(19) United States
(12) Patent Application Publication
(10) Pub. No.: US 2013/0124004 A1
(43) Pub. Date: May 16, 2013

(54) SYSTEM AND METHOD FOR CONTROLLING ELECTRICAL DEVICES

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/543,910

(22) Filed: Jul. 9, 2012

(30) Foreign Application Priority Data
Nov. 16, 2011 (TW) 100141917

(51) Int. Cl. G05B 19/18

(52) U.S. Cl. 700/302

(57) ABSTRACT

A computing device is electronically connected to a plurality of electrical devices via a controller, and is connected to an elevator control system of a building via a network. The computing device sets associations between control commands triggered by pressing floor buttons of the elevator control system and switch statuses of electric devices installed on floors of the building. When a floor button of the elevator control system is pressed by a user, a control command is generated and sent to the computing device via the network. The computing device determines the floor that the user wants to go by analyzing the control command, determines electrical devices of the floor which are associated with the control command according to the associations; and switches on the associated electrical device of the determined floor by sending the control command to the associated electrical device of the determined floor via the controller.

### BACKGROUND

1. Technical Field

The embodiments of the present disclosure relate to automatic control systems and methods, and more particularly to a system and a method for controlling electrical devices.

2. Description of Related Art

Many buildings are equipped with motion sensors in defined regions for automatically switching on electrical devices (such as lights) when sensing motion, and automatically switching off the electrical devices when no motion has been sensed. One problem is that, before approaching a defined region, people may have limited light for walking, thus cannot see hidden danger and thus, may cause people to panic. For example, when people take an elevator to a floor of a building, lights installed in certain regions of the floor may be in a switched-off status because no motion has been detected by the motion sensors.

### BRIEF DESCRIPTION OF THE DRAWINGS

FIG. 1 is a block diagram of one embodiment of a computing device including a control unit for controlling electrical devices.

FIG. 2 is a block diagram of function modules of the control unit in FIG. 1.

FIG. 3 is a flowchart of one embodiment of a method for controlling electrical devices.

FIG. 4 illustrates setting associations between control commands triggered by pressing floor buttons and switch statuses of electric devices installed on floors of a building.

FIG. 5 illustrates a control panel of an elevator control system.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

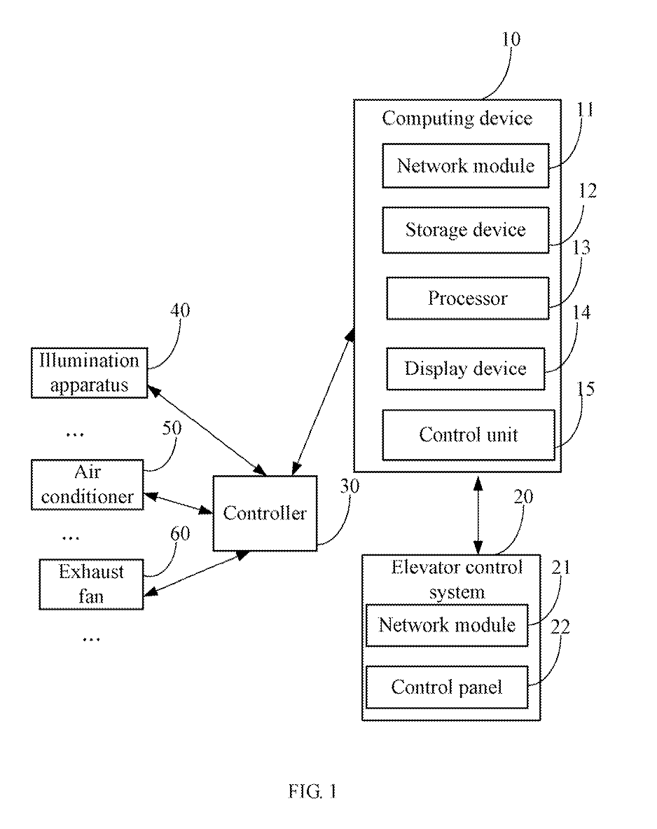

FIG. 1 is a block diagram of one embodiment of a computing device 10. The computing device 10 includes a control unit 15 for controlling electrical devices. As shown in FIG. 1, the electrical devices may include one or more illumination apparatuses 40, one or more air conditioners 50, and one or more exhaust fans 60. In this embodiment, different floors of a building (such as an office block) is equipped with the electrical devices. The electrical devices are electronically connected to the computing device 10 via a controller 30. The computing device 10 is further electronically connected to an elevator control system 20. The controller 30 may be a programmable automation controller (PAC) or a programmable logic controller (PLC). The computing device 10 may be a server or any other device that has data processing function.

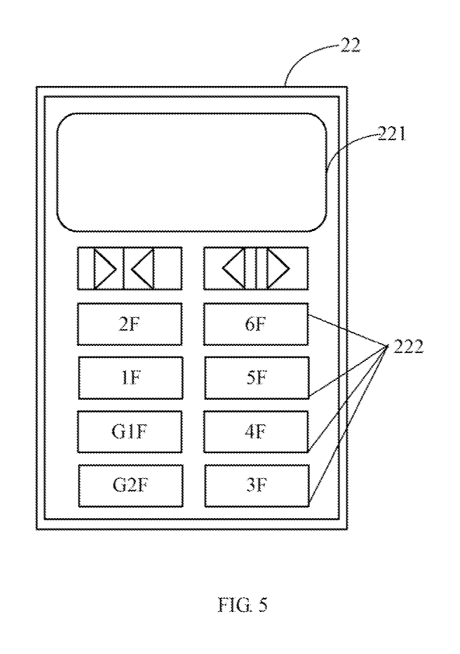

The computing device 10 further includes a network module 11, a storage device 12, a processor 13, and a display device 14. The elevator control system 20 includes a network module 21 and a control panel 22, which are installed within an elevator of the building. As shown in FIG. 5, the control panel 22 includes a display screen 221 and a plurality of buttons 222 for the floors (hereinafter, floor buttons 222) of the building. When one button 222 is pressed by a user, a control command (or a control signal) is triggered, then the network module 21 sends the control command to the computing device 10. The control unit 15 determines associated electrical devices by analyzing the control command. Then, the control command is sent to the controller 30, and the controller 30 controls switch statuses of associated electrical devices by sending the control command to the associated electrical devices.

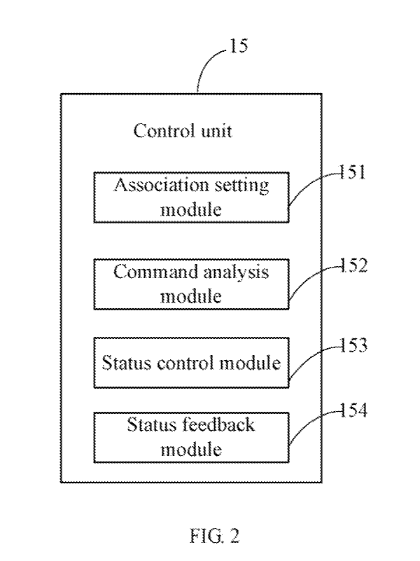

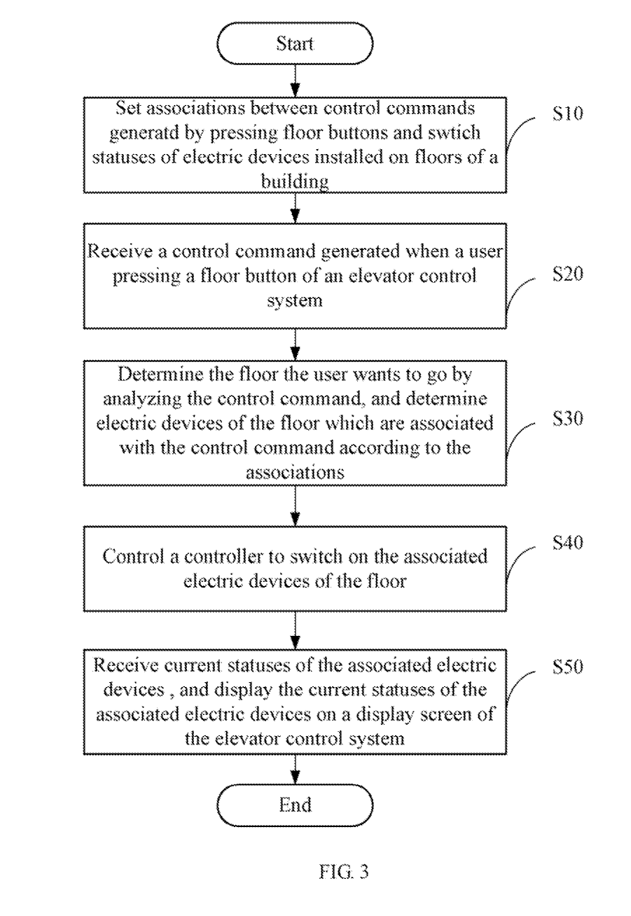

As shown in FIG. 2, the control unit 15 includes an association setting module 151, a command analysis module 152, a status control module 153, and a status feedback module 154. The modules 151-154 may comprise computerized code in the form of one or more programs that are stored in the storage device 12 and to be executed by the processor 13 of the computing device 10. A detailed description of the functions of the modules 151-154 is given in FIG. 3. The storage device 12 may be a cache or a dedicated memory, such as an erasable programmable read only memory (EPROM), a hard disk driver (HDD), or flash memory.

FIG. 3 is a flowchart of one embodiment of a method for controlling electrical devices. Depending on the embodiment, additional steps may be added, others removed, and the ordering of the steps may be changed.

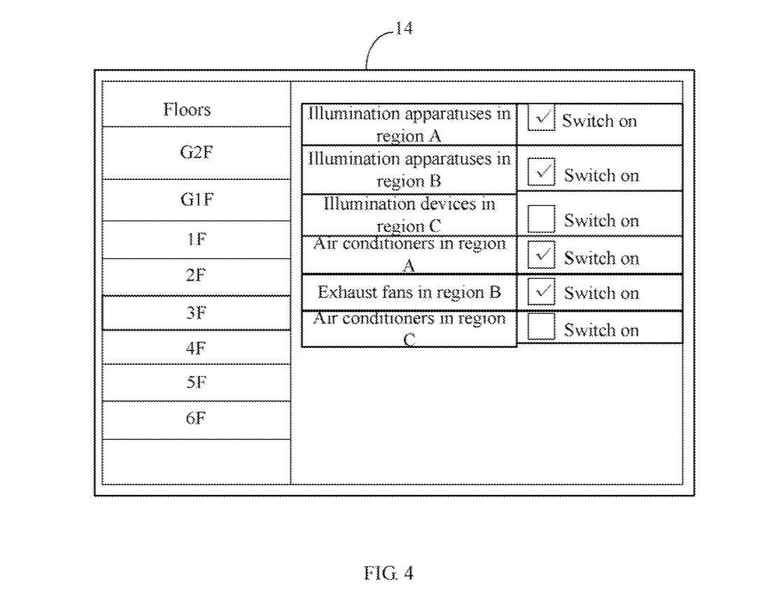

In step S10, the association setting module 151 sets associations between control commands triggered by pressing floor buttons 222 of the elevator control system 20 and switch statuses of electric devices installed on floors of a building. For example, as shown in FIG. 4, a control command, which is triggered by pressing a floor button 222 of the third floor “3F”, is set to be associated with switching on illumination apparatuses 40 arranged in regions A and B, air conditioners arranged in region A, and exhaust fans arranged in region B. The association setting module 151 stores the associations into the storage device 12.

In step S20, a control command is generated in response to a user pressing a floor button 222 (such as “3F”) on the control panel 22, the network module 21 sends the control command to the computing device 10. The network module 11 of the computing device 10 receives the control command.

In step S30, the command analysis module 152 determines the floor that the user wants to go by analyzing the control command, and determines electrical devices of the floor which are associated with the control command according to the associations. For example, the command analysis module 152 may determine the user wants to go to the third floor from the control command generated by pressing the floor button “3F”, and determine the illumination apparatuses 40 arranged in regions A and B, the air conditioners 50 arranged in region A, and the exhaust fans 60 arranged in region B of the third floor are in control of the control command generated by pressing the floor button “3F.”

In step S40, the status control module 153 controls the controller 30 to switch on the associated electrical device of the determined floor by sending the control command to the associated electrical device of the determined floor via the controller 30. For example, the control command generated by pressing the floor button “3F” is respectively sent to the air conditioners 50 arranged in region A, and the exhaust fans 60 arranged in region B of the third floor, to switch on these electrical devices.

In step S50, the controller 30 receives information in relation to the current statuses of the associated electrical devices which are sent by the associated electrical devices, and sends the information in relation to the current statuses of the associated electrical devices to the computing device 10. The computing device 10 sends the information in relation to the current statuses of the associated electrical devices to the elevator control system 20, then the elevator control system 20 displays the information in relation to the current statuses of the associated electrical devices on the display screen 21. In this embodiment, when one associated electrical device (such as a first air conditioner 40 on the third floor) has been switched on, the associated electrical device will send back a logic high-level signal to the controller 30; when one associated electrical device (such as a second air conditioner 40 on the third floor) fails to be switched on, the associated electrical device will send back a logic low-level signal to the controller 30. The status feedback module 154 sends the information in relation to the current status of the associated electrical devices to the elevator control system 20. The elevator control system 20 displays the information in relation to the current status of the associated electrical devices on the display device 221, so that the user in the elevator can know whether or not the associated electrical devices have been switched on in advance.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a computing device for controlling electrical devices electronically connected to the computing device via a controller, the computing device being connected to an elevator control system of a building via a network, the method comprising:
setting associations between control commands generated by pressing floor buttons of the elevator control system and statuses of electric devices installed on floors of the building;
receiving a control command which is generated when a floor button of the elevator control system is pressed by a user;
determining the floor that the user wants to go by analyzing the control command, and determining electrical devices of the floor which are associated with the control command according to the associations; and
controlling the controller to switch on the associated electrical device of the determined floor.

2. The method of claim 1, further comprising:
receiving information in relation to current statuses of the associated electrical devices sent back by the controller, and displaying the information in relation to the current statuses of the associated electrical devices on a display screen of the elevator system.

3. The method of claim 2, wherein a logic high-level signal is sent to the controller from an associated electrical device in response that the associated electrical device is successfully switched on.

4. The method of claim 2, wherein a logic low-level signal is sent to the controller from an associated electrical device in response that the associated electrical device fails to be switched on.

5. The method of claim 1, wherein the controller is a programmable automation controller (PAC) or a programmable logic controller (PLC).

6. A computing device being electronically connected to a plurality of electrical devices via a controller, and connected to an elevator control system of a building via a network, the computing device comprising:
a storage device;
a processor; and
one or more programs that are stored in the storage device and executed by the processor, the one or more programs comprising instructions to:
set associations between control commands generated by pressing floor buttons of the elevator control system and statuses of electric devices installed on floors of the building;
receive a control command which is generated when a floor button of the elevator control system is pressed by a user;
determine the floor that the user wants to go by analyzing the control command, and determine electrical devices of the floor which are associated with the control command according to the associations; and
control the controller to switch on the associated electrical device of the determined floor.

7. The computing device of claim 6, wherein the one or more programs further comprise instructions to:
receive information in relation to current statuses of the associated electrical devices sent back by the controller, and display the information in relation to the current statuses of the associated electrical devices on a display screen of the elevator system.

8. The computing device of claim 7, wherein a logic high-level signal is sent to the controller from an associated electrical device in response that the associated electrical device is successfully switched on.

9. The computing device of claim 7, wherein a logic low-level signal is sent to the controller from an associated electrical device in response that the associated electrical device fails to be switched on.

10. The computing device of claim 6, wherein the controller is a programmable automation controller (PAC) or a programmable logic controller (PLC).

11. A non-transitory storage medium storing a set of instructions, the set of instructions capable of being executed by a processor of a computing device for controlling electrical devices electronically connected to the computing device via a controller, the computing device being connected to an elevator control system of a building via a network, the method comprising:
setting associations between control commands generated by pressing floor buttons of the elevator control system and switch statuses of electric devices installed on floors of the building;
receiving a control command which is generated when a floor button of the elevator control system being pressed by a user, and sending the control command to the computing device via the network;
determining the floor that the user wants to go by analyzing the control command, and determining electrical devices of the floor which are associated with the control command according to the associations; and
controlling the controller to switch on the associated electrical device of the determined floor.

12. The medium of claim 11, wherein the method further comprises:
receiving information in relation to current statuses of the associated electrical devices sent back by the controller, and displaying the information in relation to the current statuses of the associated electrical devices on a display screen of the elevator system.

13. The medium of claim 12, wherein a logic high-level signal is sent to the controller from an associated electrical device in response that the associated electrical device is successfully switched on.

14. The medium of claim 12, wherein a logic low-level signal is sent to the controller from an associated electrical device in response that the associated electrical device fails to be switched on.

15. The method of claim 11, wherein the controller is a programmable automation controller (PAC) or a programmable logic controller (PLC).
